(19) United States
(12) Patent Application Publication
(10) Pub. No.: US 2024/0401913 A1
(43) Pub. Date: Dec. 5, 2024

(54) A PRODUCT AND METHOD FOR FREQUENCY SELECTIVE CAMOUFLAGE MATERIAL

(71) Applicant: SAAB AB, Linköping (SE)

(72) Inventor: Johan JERSBLAD, Västervik (SE)

(21) Appl. No.: 18/702,322

(22) PCT Filed: Oct. 12, 2022
(86) PCT No.: PCT/SE2022/050924

§ 371 Date: Apr. 17, 2024

(30) Foreign Application Priority Data
Oct. 18, 2021 (SE) 2100152-4

(51) Int. Cl. F41H 3/02; H01Q 15/00; H01Q 17/00

(52) U.S. Cl. CPC F41H 3/02; H01Q 15/0053; H01Q 17/00

(57) ABSTRACT

The present disclosure relates to a frequency selective camouflage material comprising a backing and a conductive material. The conductive material is patterned onto said backing to form a plurality of regions of conductive material, wherein each region of conductive material is electrically isolated from other regions of patterned conductive material. Each region of patterned conductive material has a diameter in the range of 5 mm to 300 mm. The camouflage material has a transmittance of at least 60% for electromagnetic radiation having a frequency below 200 MHz and at most 40% for electromagnetic radiation having a frequency in the range of 8-20 GHz.

### TECHNICAL FIELD

The present disclosure relates to camouflage materials

### BACKGROUND

Camouflage systems are typically applied to vehicles and equipment in order to avoid detection by sensor systems or the naked eye. A problem may arise when covering communication equipment with a camouflage system arranged to interact with electromagnetic radiation as the ability to transmit and receive electromagnetic signals may be disrupted by said camouflage system. This situation may also occur inadvertently when camouflage systems are employed in the proximity of communication equipment. In order to avoid disruptions in communication some parts of communication equipment, such as antenna, are often arranged to protrude out from under a camouflage cover, or are at least partially moved to a separate location.

In WO2019045625A1 a mobile camouflage system comprising a radar absorbing layer is described.

In WO2009017520A2 a radar camouflage fabric is described.

### SUMMARY

One object of the invention is to provide a camouflage system that provides an effective radar camouflage while allowing covered communication equipment to function effectively, this is accomplished by providing a camouflage material with an integrated patterned conductive material arranged to function as a low-pass filter.

This has in accordance with the present disclosure been achieved by means of a frequency selective camouflage material comprising a backing and a conductive material. The conductive material is patterned onto said backing to form a plurality of regions of conductive material. Each region of conductive material is electrically isolated from other regions of patterned conductive material. Said camouflage material has a transmittance of at least 60% for electromagnetic radiation having a frequency below 200 MHz and at most 40% for electromagnetic radiation having a frequency in the range of 8-20 GHz.

This has the advantage of providing frequency selective properties to camouflage materials allowing for high transmissivity at low frequencies (communications-frequencies) and low transmissivity at high frequencies (radar surveillance frequencies). Typically reconnaissance radars used in military systems, such as synthetic aperture radars, operate in frequencies in the range of 8-18 GHz, whereas communication equipment systems typically uses frequencies below 600 MHZ.

The term backing relates to a flexible layer, such as a polymer sheet or a canvas. Typically the backing is substantially planar, provides the structural integrity of the camouflage material and is the layer arranged furthest from the outward facing side of the camouflage material.

In some examples of the camouflage material, wherein said regions have diameters in the range of 20 mm to 300 mm.

This has the advantage of allowing regions of pattern conductive material typical to interact relatively strongly with typical radar signals and relatively weakly with typical communication signals, as electromagnetic radiation with a wavelength of 20 mm corresponds to approximately 15 GHz and a wavelength of 300 mm corresponds to approximately 1 GHz.

The term diameter of a region of patterned conductive material is the largest distance between two parts of the region of patterned conductive material. For example a square has a diameter of √2 times its side length.

It is to be understood that the expression “regions have diameters in the range of X mm to Y mm” relates to the diameter of each region of said plurality of regions of patterned conductive material.

In some examples of the camouflage material, wherein the conductive material is patterned in a repeating pattern, said repeating pattern is applied to at least 80% of the surface of one side of said backing.

In some examples of the camouflage material, wherein regions of patterned conductive material are triangular, square, rectangular, hexagonal, and/or cross shaped.

This has the advantage of allowing the same region shape to be tessellated on the backing without voids in the pattern except the spacing required for electrical isolation.

In some examples of the camouflage material, wherein said regions of patterned conductive material comprises overlapping regions of patterned conductive material separated by insulating material and/or free space.

This has the advantage of allowing the transmissivity to be lowered by adding additional layers of patterned conductive material. This further has the advantage of mitigating any inhomogeneity in transmissivity due to spacing between regions in each layer.

In some examples of the camouflage material, comprises a pigmented surface layer arranged on the backing patterned with conductive material.

This has the advantage of allowing the camouflage material to have the same visual and infrared appearance. This further has the advantage of protecting the patterned conductive material.

In some examples of the camouflage material, comprises a garnish layer, wherein the garnish layer is structured and arranged to at least partially extend out from the backing.

This has the advantage of allowing visual and infrared detection avoidance to be handled by the garnish layer and allowing radar detection avoidance to be handled by the patterned conductive material. This further has the advantage of allowing the camouflage material to have a structured, leaf-like, surface.

The present disclosure further relates to a method for producing frequency selective camouflage material. The method comprises obtaining a backing; and patterning a plurality of regions of conductive material on said backing. Each region of conductive material is electrically isolated from other regions of patterned conductive material. Said camouflage material has a transmittance of at least 60% for electromagnetic radiation having a frequency below 200 MHz and at most 40% for electromagnetic radiation having a frequency in the range of 8-20 GHz.

This has the advantage of allowing producing frequency selective camouflage materials configured for high transmissivity at low frequencies (communications-frequencies) and low transmissivity at high frequencies (radar frequencies).

In some examples of the method, wherein patterning a plurality of regions of said backing with a conductive material comprises utilizing screen printing.

This has the advantage of allowing a large amount of conductive material to be printed per region. This further has the advantage of allowing large scale prints of tessellated regions to be executed.

In some examples of the method, comprises surface treating said backing patterned with conductive material, wherein surface treating comprises colouring areas of said backing at least in parts between said regions of patterned conductive material.

This has the advantage of allowing a surface layer providing physical protection and flame retardants to be added.

In some examples of the method, wherein comprises garnishing said backing patterned with conductive material, wherein garnishing comprises adding a structured garnish layer and/or incising the backing.

This has the advantage of providing a structured, leaf-like, surface of the camouflage material.

In some examples of the method, wherein patterning a plurality of regions of conductive material on said backing comprises patterning overlapping regions of patterned conductive material, and separating overlapping regions utilizing insulating material and/or free space.

This has the advantage of allowing transmissivity to be lowered by adding additional layers of patterned conductive material. This further has the advantage of mitigating any inhomogeneity in transmissivity due to spacing between regions in each layer.

### BRIEF DESCRIPTION OF THE DRAWINGS

FIG. 1a-b show schematically a frequency selective camouflage material

FIG. 2a-b depict schematically frequency selective camouflage materials

FIG. 3 shows schematically a method for producing frequency selective camouflage material

### DETAILED DESCRIPTION

Throughout the figures, same reference numerals refer to same parts, concepts, and/or elements. Consequently, what will be said regarding a reference numeral in one figure applies equally well to the same reference numeral in other figures unless not explicitly stated otherwise.

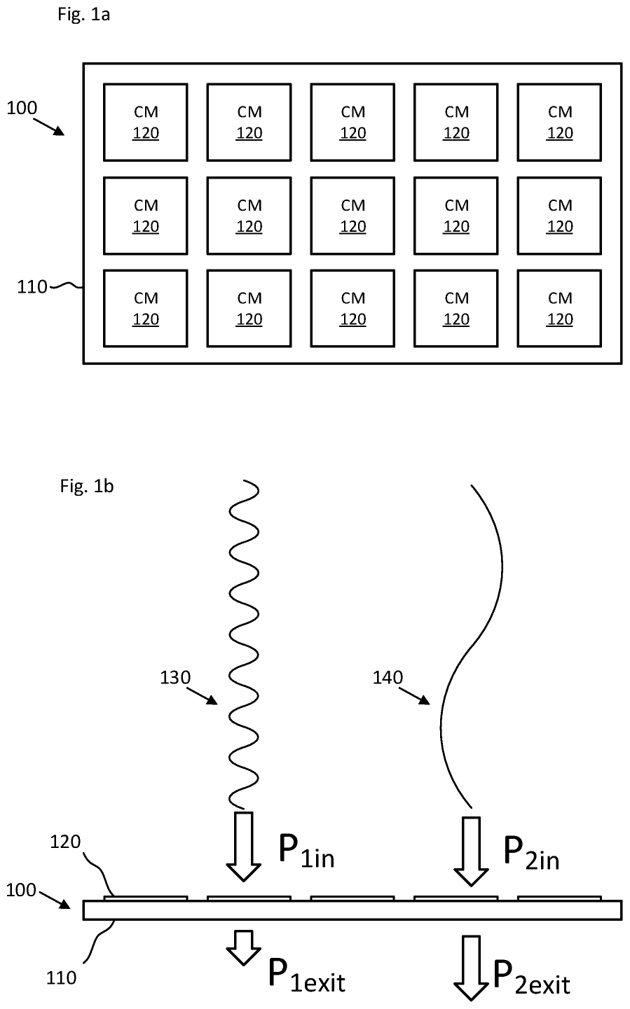

FIG. 1a-b shows schematically an example frequency selective camouflage material 100. FIG. 1a shows one side of said camouflage material 100 comprising a conductive material 120 patterned in regions. FIG. 1b shows a side view of said camouflage material 100 with representations of electromagnetic radiation 130,140 travelling through said patterned conductive material 120. Note that FIG. 1a-b aim to explain the camouflage material 100 and its interaction with electromagnetic radiation. The depicted thickness, pattern geometry and size relationship between regions and visualized electromagnetic radiation wavelengths may not be to scale.

FIG. 1a shows the camouflage material 100 comprising a backing 110 and the patterned conductive material, CM, 120. The patterned conductive material 120 is patterned on a plurality of regions on the backing 110, wherein said plurality of regions of patterned conductive material 120 each are electrically isolated from each other. Typically the backing 110 is structured and/or porous whereby the patterned conductive material 120 may penetrate into said backing 110 (not shown).

The term backing relates to a flexible layer, such as a polymer sheet or a canvas. Typically the backing is substantially planar, provides the structural integrity of the camouflage material 100 and is the layer arranged furthest from the outward facing side of the camouflage material 100.

In some examples, the backing 110 is a flexible polymer layer, a base camouflage textile, a fabric and/or a net. In some examples, the backing 110 comprises textile. In some of these examples the backing 110 comprises polyester fabric.

In some examples, the backing 110 comprises polyamide, polypropylene, polyvinyl chloride, and/or aramid.

In some examples, the backing 110 is an electrical insulator. In some examples, the backing 110 comprises an electrically insulating material. In some examples, the backing 110 is electrically insulating at least between said patterned regions. In some examples, the backing 110 is electrically insulating at least at the intersect between the backing 110 and said regions of patterned conductive material 120.

In some examples, the regions of patterned conductive material 120 have a sheet resistance of 0-1000 Ohm/sq. In some of these examples, the regions of patterned conductive material 120 have a sheet resistance of 100-500 Ohm/sq. In some of these examples, the regions of patterned conductive material 120 have a sheet resistance of 150-300 Ohm/sq. In some examples, the regions of patterned conductive material 120 have a sheet resistance of 10-50 Ohm/sq. In some examples, the regions of patterned conductive material 120 have a sheet resistance of 400-2000 Ohm/sq.

It is to be understood that the expression “regions of patterned conductive material 120 have a sheet resistance of X-Y Ohm/sq” relates to the sheet resistance of each region of said plurality of regions of patterned conductive material.

In some examples, the patterned conductive material 120 comprises electrically conductive particles. In some of these examples the electrically conductive particles are comprised in a foam or fabric material, such as a polyolefin, polyester or polyurethane foam or fabric. In some examples, said conductive material 120 comprises carbon black, metal and/or graphene.

The term “regions of patterned conductive material” relates to regions with substantially planar layers of conductive material. Typically the regions of patterned conductive material 120 comprises a repeating pattern of regions, such as a tessellated pattern of squares or hexagons with some separation between regions. Typically the regions of patterned conductive material 120 is selected to result in a desired frequency response, such as a low-pass filter with a cutoff frequency of 2 GHz.

The term electrically isolated is to be understood as being surrounded by electrical insulators and/or free space. Electrically isolated regions of patterned conductive material 120 relates to the electrical resistance within each region of patterned conductive material 120 typically being several orders of magnitude smaller than the resistance between regions of patterned conductive material 120.

The backing 110, the conductive material 120, and the geometry of regions of patterned conductive material 120 are not limited to the examples.

FIG. 1b shows a side view of said camouflage material 100, depicting a cross-section of said backing 110 and patterned conductive material 120. FIG. 1b further visualizes example electromagnetic radiation 130,140 travelling through said patterned conductive material 120, wherein said visualized example electromagnetic radiation is of a first wavelength 130 and a second wavelength 140.

The transmittance of an object for radiation travelling through said object is defined as a ratio of radiation's power exiting an object divided by radiation's power incident on the object. FIG. 1b depicts for the electromagnetic radiation of the first wavelength 130 an incident power, P₁ᵢₙ, and an exit power, P₁ₑₓᵢₜ. FIG. 1b depicts for the electromagnetic radiation of the second wavelength 130 an incident power, P₂ᵢₙ, and an exit power, P₂ₑₓᵢₜ. In the example, the first wavelength is shorter than a diameter corresponding to the regions of patterned conductive material 120, and the second wavelength is significantly longer than said region diameter.

The term diameter of a region of patterned conductive material 120 is the largest distance between two parts of the region of patterned conductive material 120. For example a square has a diameter of √2 times its side length. Typically the thickness of a region of patterned conductive material 120 is significantly smaller than its length and width, thus the diameter of the region of patterned conductive material 120 is almost the same as the diameter of a 2D shape corresponding to the regions of the pattern, such as a square or a hexagon.

In some examples, the camouflage material 100 has a transmittance of at least 60% for electromagnetic radiation having a frequency below 200 MHz and at most 40% for electromagnetic radiation having a frequency in the range of 8-20 GHz.

In some examples, the camouflage material 100 has a transmittance of at least 80% for electromagnetic frequencies below 200 MHz and at most 25% for electromagnetic frequencies in the range 6-20 GHz.

In some examples, the camouflage material 100 has a transmittance of at least 60%, or at least 70%, or at least 80%, or at least 90% for electromagnetic frequencies below 200 MHz. In some of these examples, the camouflage material 100 has a transmittance of at least 60%, or at least 70%, or at least 80%, or at least 90% for electromagnetic frequencies below 300 MHz, or for electromagnetic frequencies below 400 MHz, or for electromagnetic frequencies below 500 MHz.

In some examples, the camouflage material 100 has a transmittance of at most 40%, or at most 35%, or at most 25%, or at most 15% for electromagnetic frequencies in the range 8-20 GHz, or in the range 6-20 GHZ, or in the range 6-40 GHZ, or in the range 4-30 GHz. In some of these examples, the camouflage material 100 is a band-pass filter in a part of the electromagnetic spectrum comprising said range of frequencies.

In some examples, the camouflage material 100 further has a transmittance of at least 50% for electromagnetic frequencies between 1210 MHz and 1590 MHz, such as the GPS frequency bands L1 and L2. In some of these examples, the camouflage material 100 has a transmittance of at least 50% for electromagnetic frequencies between 1150 MHz and 1590 MHz.

The term transmittance relates to the fraction of incident electromagnetic power that is transmitted through a sample. The expression “transmittance of the patterned conductive material” relates to the average transmittance through said patterned conductive material 120.

It is to be understood that the expression “the camouflage material transmittance” relates to the transmittance through the backing 110 and one or more layers of the regions of patterned conductive material 120. For some examples, the camouflage material transmittance is substantially same as the transmittance of the regions of patterned conductive material for at least some frequency ranges. Typically, the plurality of regions of patterned conductive material is the component of the camouflage material with the greatest impact on transmittance for the frequency ranges listed above.

In some examples, the one or more layers of the regions of patterned conductive material 120 has a transmittance of at least 60% for electromagnetic radiation having a frequency below 200 MHz and at most 40% for electromagnetic radiation having a frequency in the range of 8-20 GHz.

In some examples, the one or more layers of the regions of patterned conductive material 120 has a transmittance of at least 80% for electromagnetic frequencies below 200 MHz and at most 25% for electromagnetic frequencies in the range 6-20 GHz.

In some examples, the one or more layers of the regions of patterned conductive material 120 has a transmittance of at least 60%, or at least 70%, or at least 80%, or at least 90% for electromagnetic frequencies below 200 MHz. In some of these examples, the one or more layers of the regions of patterned conductive material 120 has a transmittance of at least 60%, or at least 70%, or at least 80%, or at least 90% for electromagnetic frequencies below 300 MHz, or for electromagnetic frequencies below 400 MHZ, or for electromagnetic frequencies below 500 MHz.

In some examples, the one or more layers of the regions of patterned conductive material 120 has a transmittance of at most 40%, or at most 35%, or at most 25%, or at most 15% for electromagnetic frequencies in the range 8-20 GHZ, or in the range 6-20 GHZ, or in the range 6-40 GHz, or in the range 4-30 GHz. In some of these examples, the one or more layers of the regions of patterned conductive material 120 is a band-pass filter in a part of the electromagnetic spectrum comprising said range of frequencies.

In some examples, the one or more layers of the regions of patterned conductive material 120 further has a transmittance of at least 50% for electromagnetic frequencies between 1210 MHz and 1590 MHz, such as the GPS frequency bands L1 and L2. In some of these examples, the one or more layers of the regions of patterned conductive material 120 has a transmittance of at least 50% for electromagnetic frequencies between 1150 MHz and 1590 MHz. In the example, said first wavelength is similar to the diameter of regions resulting in a probability of interaction between said electromagnetic radiation of the first wavelength 130 and the patterned conductive material 120 that is comparable to the corresponding probability of interaction for a large continuous layer of conductive material 120. In contrast, the mismatch between the diameter of regions and said second wavelength results in a probability of interaction between said electromagnetic radiation of the second wavelength 140 and the patterned conductive material 120 being significantly lower than the probability for interaction with the continuous layer of conductive material 120. Thus by adjusting the diameter of said regions of patterned conductive material 120 the transmittance for a electromagnetic radiation of desired wavelengths to be transmitted may be increased, wherein adjusting typically comprises reducing said diameter to significantly smaller than said desired wavelengths to be transmitted.

In some examples, the patterned conductive material 120 penetrates into the underlying backing 110. In some of these examples, the backing 110 comprises regions with patterned conductive material 120 on both sides of the backing 110 and/or integrated into said backing 110. In some of these examples, the patterned conductive material 120 connects both sides of the backing 110 in said regions. In some examples, the patterned conductive material 120 is a conductive wire running through the backing 110.

In some examples, the conductive material 120 is patterned in a repeating pattern, wherein said repeating pattern is applied to substantially all of at least one side of said backing 110.

In some examples, the conductive material 120 is patterned in a repeating pattern, wherein said repeating pattern covers preferably at least 60% of the surface area of one side of said backing 110, more preferably 80% of said surface area, or most preferably 90% of said surface area.

It is to be understood that the expression “the repeating pattern covers at least X % of the backing” relates to the area of the backing 110 being covered by conductive material. Said expression may describe a maximum sparsness of the plurality of regions of patterned conductive material 120 on the backing 110.

In some examples, the conductive material 120 is patterned in a repeating pattern on both sides of said backing 110, wherein said repeating pattern covers preferably at least 60% of the surface area of both sides of said backing 110, more preferably 80% of said surface area, or most preferably 90% of said surface area.

In some examples, said regions are triangular, square, rectangular, hexagonal, and/or cross shaped. In some examples, said regions each is a region with a width of at least half its length, such as a geometry of a triangle, a rectangle, or a hexagon.

In some examples, said each region comprises three or more separated parts connected by bridges (not shown) of conductive material 120. In some of these examples each region is four square parts arranged as a square and being connected by four bridges of conductive material 120 at each pair of adjacent square sides, or each region is three hexagon parts arranged adjacent to each other and being connected by three bridges of conductive material 120. Alternatively each region is seven hexagon parts arranged as a hexagon and being connected by twelve bridges of conductive material 120.

In some examples, each region of patterned conductive material 120 is a first shape except a part of said first shape defined by a second shape, such as a region being defined by a square and a smaller square inside without patterned conductive material 120. In some of these examples part of said second shape is defined by a third shape, wherein the part defined by the third shape contains patterned conductive material 120. In some of these examples the patterned conductive material 120 of each region is connected.

In some examples of the camouflage material 100, wherein said regions have diameters in the range of 20 mm to 300 mm. In some examples, said regions have diameters in the range of 50 mm to 150 mm. In some examples, said regions have diameters in the range of 5 mm to 500 mm. In some examples, said regions have diameters in the range of 2 mm to 2m. In some examples, each region of the pattern of patterned conductive material 120 has substantially the same shape and size.

Electromagnetic radiation with a wavelength of 20 mm is approximately 15 GHz and a wavelength of 300 mm is approximately 1 GHz. As an example a patterned conductive material 120 with regions of 20 mm diameter may be assumed to have a relatively low transmissivity for some electromagnetic radiation frequencies at and above 7.5 GHZ. Whereas a patterned conductive material with regions of 300 mm diameter may be assumed to have a relatively low transmissivity for some electromagnetic radiation frequencies at and above 500 MHz.

In some examples, the regions of patterned conductive material 120 comprises regions of patterned conductive material 120 overlapping with other regions of patterned conductive material 120, wherein overlapping regions are separated by insulating material and/or free space, such as air. The term overlapping regions of patterned conductive material 120 herein relates to regions overlapping in directions substantially perpendicular to a plane relating to the camouflage material 100.

FIG. 1b depicts the electromagnetic radiation of the first wavelength 130 and the second wavelength 140 approaching the example camouflage material 100. In a use example with camouflage material 100 covering communication equipment arranged to transmit electromagnetic radiation of the second wavelength 140 in order to protect against incoming electromagnetic radiation of the first wavelength 130 from active surveillance equipment, then the electromagnetic radiation of the first wavelength 130 and the second wavelength 140 typically approach the camouflage material 100 from opposite sides.

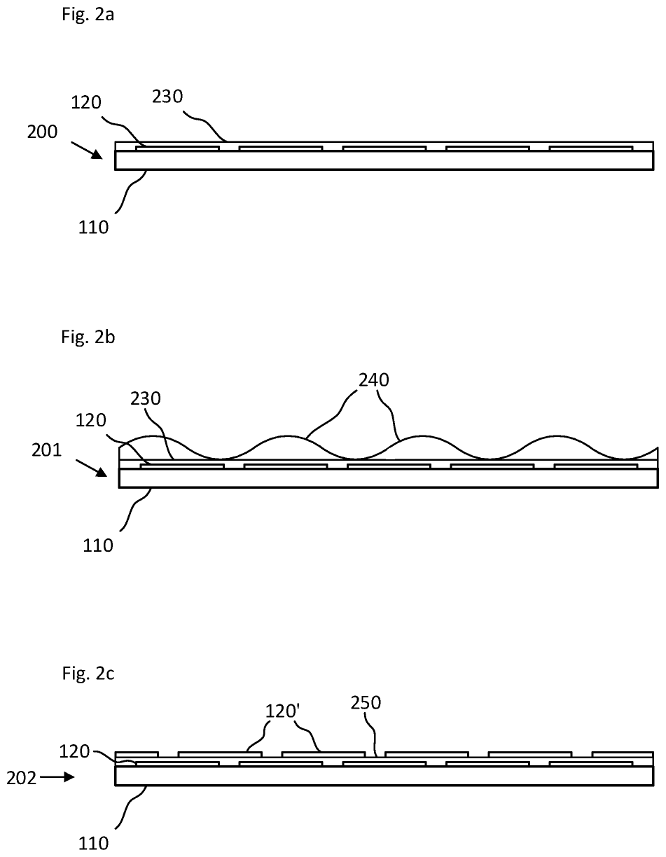

FIG. 2a-c depict schematically three example frequency selective camouflage materials. FIG. 2a-c shows side views of said camouflage materials.

FIG. 2a depicts schematically an example camouflage material 200 comprising a backing 110 and a patterned conductive material 120. The backing 110 and patterned conductive material 120 may be the backing 110 and patterned conductive material 120 described in FIG. 1a-b. The patterned conductive material 120 is patterned on a plurality of regions of the backing 110, wherein said plurality of regions of patterned conductive material 120 each are electrically isolated from each other. The example camouflage material 200 further comprises a surface layer 230, wherein the surface layer 230 is pigmented.

The surface layer 230 may provide a colour and/or physical protection to the backing 110 and/or the regions of patterned conductive material 120.

In some examples, the surface layer 230 comprises a coating of paint.

In some examples, the surface layer 230 provides a camouflage pattern to said camouflage material 200.

In some examples, the surface layer 230 comprises a flame retardant.

In some examples, the surface layer 230 is an electrical insulator.

In some examples, the surface layer 230 covers at least the backing 110 between regions of patterned conductive material 120. In some of these examples the surface layer 230 covers at least the backing 110 between regions of patterned conductive material 120 and the regions of patterned conductive material 120.

FIG. 2b depicts schematically an example camouflage material 201 comprising a backing 110, a patterned conductive material 120, and a surface layer 230. The surface layer 230 may be the surface layer 230 described in FIG. 2a. The patterned conductive material 120 is patterned on a plurality of regions of the backing 110, wherein said plurality of regions of patterned conductive material 120 each are electrically isolated from each other. The example camouflage material 201 further comprises a garnish layer 240, wherein the garnish layer 240 is arranged to at least partially extend out from the surface layer 230, such as a structured surface mimicking foliage.

The expression “garnish layer 240 arranged to at least partially extend out from the surface layer 230” is to be understood that said garnish layer 240, unlike a planar layer, comprises parts that significantly extending out from the surface layer 230 and/or provide an uneven geometry, such as a tangled yarn.

In some examples, the garnish layer 240 is incised or “leaf cut”, whereby a three dimensional leafy effect may be provided.

It is to be understood that the garnish layer 240 is not limited to a repeating shape, such as depicted in FIG. 2b. Typically garnish layers 240 are arranged to have highly irregular colours, surfaces and/or geometries.

In some examples, the garnish layer 240 surface is a plurality of colours.

In some examples, the garnish layer 240 comprises a matte (i.e. non-glossy) surface.

In some examples, the garnish layer 240 comprises a flame retardant.

In some examples, the garnish layer 240 comprises areas with significantly different thermal emissivity, thereby obstructing thermal reconnaissance.

In some examples, the garnish layer 240 comprises a textile and/or a net.

In the example in FIG. 2b the optical properties of the example camouflage material 201 is based on the patterned conductive material 120, the surface layer 230 and the garnish layer 240, wherein radar properties are based on the patterned conductive material 120 and wherein visual and infrared properties are based on the surface layer 230 and the garnish layer 240.

FIG. 2c depicts schematically an example camouflage material 202 comprising a backing 110 and a patterned conductive material 120. The patterned conductive material 120 is patterned on a plurality of regions on the backing 110. The backing 110 and patterned conductive material 120 may be the backing 110 and patterned conductive material 120 described in FIG. 1a-b. The camouflage material 202 further comprises additional regions of patterned conductive material 120′ overlapping said regions of conductive material 120 patterned on the backing 110. The camouflage material 202 further comprises means for electrically separating said overlapping regions of patterned conductive material 120,120′. The plurality of regions of patterned conductive material 120,120′ are each electrically isolated from each other. In the example camouflage material 202 in FIG. 2c the overlapping regions of patterned conductive material 120,120′ are separated by a layer of insulating material 250, wherein the layer of insulating material 250 is a flexible polymer.

In some examples, the camouflage material 202 comprises a plurality of sets of at least three overlapping regions of patterned conductive material 120,120′. In some of these examples the plurality of sets comprise at least four overlapping regions of patterned conductive material 120,120′. In some of these examples the plurality of sets comprise at least five overlapping regions of patterned conductive material 120,120′. The term overlapping regions of patterned conductive material is to be understood as regions overlapping in directions substantially perpendicular to a plane relating to the camouflage material 202.

In some examples, the overlapping regions of patterned conductive material 120 are electrically separated by insulating material 250 and/or free space, such as air.

The examples of the camouflage material 200,201,202 in FIG. 2a-c comprising the surface layer 230, the garnish layer 240 and/or the layer of insulating material 250 separating overlapping regions of patterned conductive material 120,120′ may be combined.

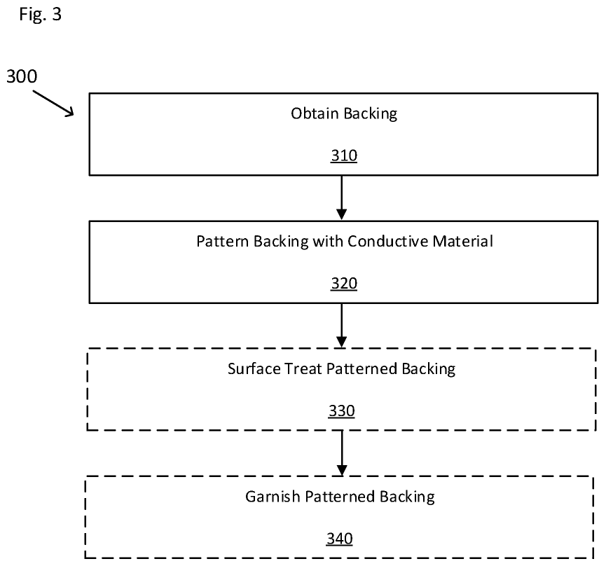

FIG. 3 shows schematically a method for producing frequency selective camouflage material, the method 300 comprises
obtaining 310 a backing; and
patterning 320 a plurality of regions of conductive material on said backing;
wherein each region of conductive material is electrically isolated from other regions of patterned conductive material, and
wherein said camouflage material has a transmittance of at least 60% for electromagnetic radiation having a frequency below 200 MHz and at most 40% for electromagnetic radiation having a frequency in the range of 8-20 GHz.

In some examples, said backing comprises a flexible polymer layer, a base camouflage textile, a fabric and/or a net.

In some examples, said backing is electrically insulating.

In some examples, patterning 320 the plurality of regions of said backing with a conductive material comprises patterning substantially all of at least one side of said backing.

In some examples, patterning 320 a plurality of regions of said backing with a conductive material comprises utilizing screen printing.

In some examples, the method 300 further comprises surface treating 330 said backing patterned with conductive material, wherein surface treating 330 comprises colouring areas of said backing at least in parts between said regions of patterned conductive material.

In some examples, the method 300 further comprises garnishing 340 said backing patterned with conductive material, wherein garnishing 340 comprises adding a structured garnish layer and/or incising or “leaf cutting” the backing. In some of these examples garnishing 340 may provide a three dimensional leafy effect.

In some examples, patterning 320 a plurality of regions of conductive material on said backing comprises patterning overlapping regions of conductive material, and separating overlapping regions utilizing insulating material and/or free space.

1. A frequency selective camouflage material comprising a backing and a conductive material,
wherein
the conductive material is patterned onto said backing to form a plurality of regions of conductive material, wherein each region of conductive material is electrically isolated from other regions of patterned conductive material;
wherein each region of patterned conductive material has a diameter in the range of 5 mm to 300 mm; and
wherein said camouflage material has a transmittance of at least 60% for electromagnetic radiation having a frequency below 200 MHz and at most 40% for electromagnetic radiation having a frequency in the range of 8-20 GHz.

2. The camouflage material according to claim 1, wherein said regions have diameters in the range of 20 mm to 300 mm.

3. The camouflage material according to claim 1, wherein the conductive material is patterned in a repeating pattern, wherein said repeating pattern is applied to at least 80% of the surface of one side of said backing.

4. The camouflage material according to claim 1, wherein said conductive material comprises carbon black, metal and/or graphene.

5. The camouflage material according to claim 1, wherein regions of patterned conductive material are triangular, rectangular, hexagonal, and/or cross shaped.

6. The camouflage material according to claim 5, wherein said regions of patterned conductive material comprises overlapping regions of patterned conductive material separated by insulating material and/or free space.

7. The camouflage material according to claim 1, further comprising a pigmented surface layer arranged on the backing patterned with conductive material.

8. The camouflage material according to claim 1, further comprising a garnish layer, wherein the garnish layer is structured and arranged to at least partially extend out from the backing.

9. The camouflage material according to claim 1, further having a transmittance of at least 80% for electromagnetic frequencies below 400 MHz and/or at most 30% for electromagnetic frequencies in the range 6-40 GHz.

10. A method for producing frequency selective camouflage material, the method comprises:
obtaining a backing; and
patterning a plurality of regions of conductive material on said backing;
wherein each region of conductive material is electrically isolated from other regions of patterned conductive material;
wherein each region of patterned conductive material has a diameter in the range of 5 mm to 300 mm; and
wherein said camouflage material has a transmittance of at least 60% for electromagnetic radiation having a frequency below 200 MHz and at most 40% for electromagnetic radiation having a frequency in the range of 8-20 GHz.

11. The method according to claim 10, wherein patterning the plurality of regions of said backing with a conductive material comprises patterning a repeating pattern, and wherein said repeating pattern covers at least 80% of the surface area of one side of said backing.

12. The method according to claim 10, wherein patterning a plurality of regions of said backing with a conductive material comprises utilizing screen printing.

13. The method according to claim 10, further comprising surface treating said backing patterned with conductive material, wherein surface treating comprises colouring areas of said backing at least in parts between said regions of patterned conductive material.

14. The method according to claim 10, further comprising garnishing said backing patterned with conductive material, wherein garnishing comprises adding a structured garnish layer and/or incising the backing.

15. The method according to claim 10, wherein patterning a plurality of regions of conductive material on said backing comprises patterning overlapping regions of patterned conductive material, and separating overlapping regions utilizing insulating material and/or free space.
